(19) United States
(12) Patent Application Publication
(10) Pub. No.: US 2010/0071063 A1
(43) Pub. Date: Mar. 18, 2010

(54) SYSTEM FOR AUTOMATIC DETECTION OF SPYWARE

(75) Inventors: Hao Wang, Madison, WI (US); Somesh Jha, Madison, WI (US); Vinod Ganapathy, Highland Park, NJ (US)

Correspondence Address: WISCONSIN ALUMNI RESEARCH FOUNDATION, C/O BOYLE FREDRICKSON S.C, 840 North Plankinton Avenue, Milwaukee, WI, 53203, US

(73) Assignee: WISCONSIN ALUMNI RESEARCH FOUNDATION, MADISN, WI (US)

(21) Appl. No.: 12/515,843

(22) PCT Filed: Nov. 28, 2007
(86) PCT No.: PCT/US07/85752

§ 371 Date: May 21, 2009

Related U.S. Application Data
(60) Provisional application No. 60/867,728, filed on Nov. 29, 2006.

(51) Int. Cl. G06F 21/00

(52) U.S. Cl. 726/23

(57) ABSTRACT

An automatic system for spyware detection and signature generation compares packets of output from a computer in response to standard user inputs, to packets of a standard output set derived from a known clean machine. Differences between these two packet sets are analyzed with respect to whether they relate to unknown web servers and whether they incorporate user-derived information. This analysis is used to provide an automatic detection of and signature generation for spyware infecting the machine.

### CROSS-REFERENCE TO RELATED APPLICATIONS

This application claims the benefit of U.S. Provisional Application 60/867,728 filed Nov. 29, 2006 and hereby incorporated by reference.

### STATEMENT REGARDING FEDERALLY SPONSORED RESEARCH OR DEVELOPMENT

### BACKGROUND OF THE INVENTION

The present invention relates to systems for combating spyware on computers and in particular to a system that may automatically detect and generate signatures for unknown spyware.

Spyware are programs that run on computers without the knowledge or permission of a user and which steal sensitive or private information from the user and forward that information to a remote site. Examples of spyware are keyloggers which capture a user's keystrokes, tracking software which monitor the user's destination on the web, screen scrapers which pull data from the user's display screen, and Trojans which download and install other spyware. Some spyware masquerades as benign computer programs intended to provide useful functionality, such as browser plug-ins and extensions.

The stolen information obtained by spyware can be used for criminal activity, for example, if financial information or passwords are stolen. Increasingly, spyware is used to target unwanted advertising to the user, triggered for example, by the user's browsing activity.

Unlike other malware, such as viruses, spyware is intended to remain hidden on the computer. This very characteristic makes it difficult to detect spyware; a recent study has reported that as many as 80% of computers are spyware infected.

Current techniques for spyware detection use “signatures” of known spyware, for example character strings found in the binary executables of the spyware or found in network traffic produced by the spyware. Detecting spyware is done by analyzing the application programs on the computer and/or monitoring network communications for matches to the signatures.

Generating signatures for this approach is a time-consuming manual process. Because signatures are normally developed on a post hoc basis, this technique is principally effective against known spyware for which a signature has been developed, and is relatively ineffective against new or unknown spyware.

### BRIEF SUMMARY OF THE INVENTION

The present invention automatically detects both known and unknown spyware by monitoring deviations from normal network activity when a computer is subjected to a set of test “user” inputs. New outgoing network packets that carry information about the user (for example information from the test user inputs) and/or that provide information to an unknown remote server, are a strong indication of a spyware infection. When spyware is discovered, a warning may be provided to the user. In addition, the outgoing network packets produced by the spyware, identified by this process, may be used to simply and automatically generate signatures of the spyware for use by other computers.

Specifically, the present invention provides a method of detecting spyware comprising the steps of identifying a set of standard output packets generated by a “clean” computer in response to a given set of user inputs. These same user inputs are then applied to an “unknown” computer and differences between the standard output packets and the output packets of the “unknown” computer are identified. Based on these differences, likelihood that the unknown computer is infected with spyware is assessed.

It is thus one feature of at least one embodiment of the invention to provide an automatic method of detecting unknown spyware based on behavior rather than signatures. It is another feature of at least one embodiment of the invention to provide a simple and reliable method to distinguish normal browser behavior from spyware behavior.

The invention may determine whether the differences in output packets include output packets addressed to an unknown server.

It is thus another feature of at least one embodiment of the invention to eliminate false positives, for example, resulting from minor modification of benign web sites used in developing the standard output packets.

The invention may determine whether the differences in output packets include output packets that have data correlated with the given set of user inputs.

It is another feature of at least one embodiment of the invention to provide a detection system that is well suited to identify a fundamental characteristic of spyware of sending out user derived information.

The invention may assess a threat level based on both whether the output packets from the unknown computer include addresses of an unknown server and whether the data is correlated with the given set of user inputs.

It is therefore another feature of at least one embodiment of the invention to provide for a multilevel ranking of the probability that a given program is spyware to allow tailoring of the detection process to the requirements of a user.

The user inputs may be automatically generated and input to the computer by a program running on the computer.

It is another feature of at least one embodiment of the invention to provide for automatic testing for spyware without user intervention.

The given set of user inputs may be selected from a set of common server addresses.

It is another feature of at least one embodiment of the invention to provide benchmark user inputs that are commonly used and to which spyware is likely to be sensitive.

The given set of user inputs may be selected in part by analyzing executable programs on the computer for web addresses.

It is a feature of at least one embodiment of the invention to tailor the user input to spyware already on the user's system.

As used herein, the “clean” computer having a known clean state and the “unknown” computer having an unknown state may be implemented as different computer hardware, or may be the same computer hardware executing the same program at different times, or the same computer hardware executing two independent instances of a program.

It is thus another feature of at least one embodiment of the invention to provide a system that may readily be used on an individual computer or multiple computers with arbitrary hardware and software configurations.

A “clean” and “unknown” computer, for example, may be implemented as two browser programs executing on the same computer hardware, where one browser is a standard browser, susceptible to spyware, and the other browser is configured not to accept browser plug ins.

It is thus another feature of at least one embodiment of the invention to provide a system that may be used on a continuous basis, on a single machine, to analyze and detect possible spyware infection. In this case, the standard user inputs may be any inputs by the actual user.

Alternatively, the standard user inputs may be developed on different computer hardware initialized with the same software as the “unknown” computer and having a known clean state.

It is therefore another feature of at least one embodiment of the invention to provide a system that may be used by a computer manufacturer for a standard line of computers manufactured by that manufacturer.

The invention may further include the step of extracting a signature from the differences between the standard output packets and the output packets of the “unknown” computer and providing signatures to a monitoring program.

It is thus another aspect of the invention to provide a system that may automatically generate spyware signatures for use with network intrusion detection devices and the like.

The signature may be a longest common subsequence of the differences.

It is another feature of at least one embodiment of the invention to provide a signature generating mechanism that makes use of the differential analysis already used by the present invention in detecting spyware behavior.

The steps of the invention may be repeated periodically, or may be repeated upon a loading of new programs into the computer of unknown state.

It is another feature of at least one embodiment of the invention to provide a system that may operate in the background without user intervention.

It is another feature of at least one embodiment of the invention to provide a system that does not require access to a computer that is wholly free from spyware.

These particular features and advantages may describe only some embodiments falling within the claims and thus do not define the scope of the invention.

### BRIEF DESCRIPTION OF THE DRAWINGS

FIG. 1 is a schematic representation of a network of different computers showing three embodiments of the present invention;

FIG. 2 is a detailed block diagram of one computer of FIG. 1 showing data flow between an operating system of the computer, spyware programs or programs that may be spyware infected, and the spyware detection program of the present invention;

FIG. 3 is a detailed block diagram of the spyware detection program of FIG. 2 showing the tasks of collecting and analyzing standard network outputs and modified networked outputs such as may be performed on one or more of the computers of FIGS. 1 and 2;

FIG. 4 is a figure similar to that of FIG. 2 showing implementation of the present invention in a program that may be susceptible to spyware infection;

FIG. 5 is a block diagram of a browser showing an embodiment of the invention providing improved identification of user-sourced information used to identify spyware generated output packets; and

FIG. 6 is a block diagram depicting a scanning process used to find server addresses that may evoke spyware behavior.

### DETAILED DESCRIPTION OF THE PREFERRED EMBODIMENT

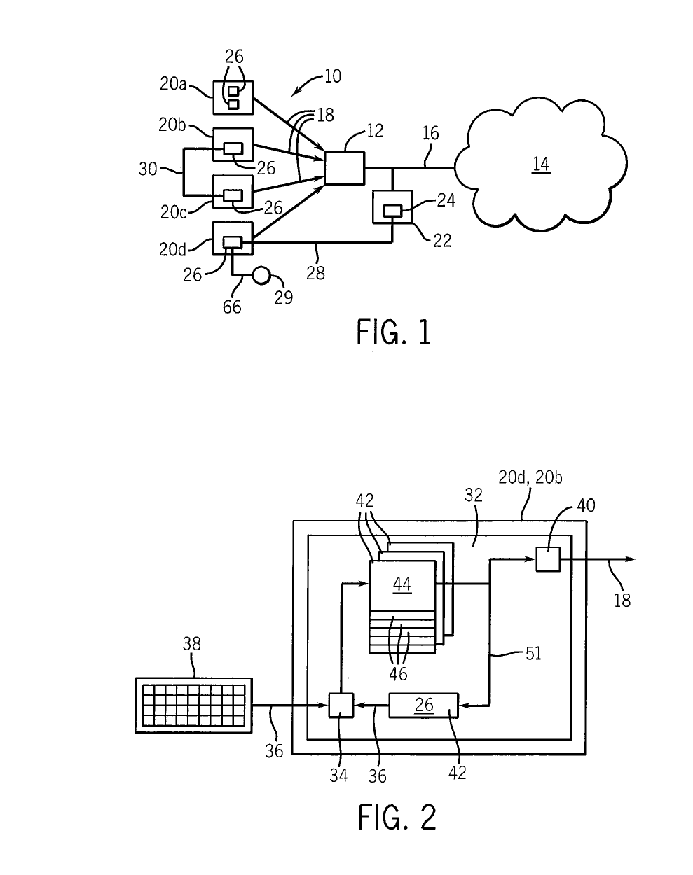

Referring now to FIG. 1 a network 10 may include, for example, an edge router 12 connected to the Internet 14 or the like by a network line 16 and communicating with multiple local network connections 18 with computers 20a-20d.

The network 10 may further include a network intrusion detection system (NIDS) 22 attached to the network line 16 to monitor network traffic to detect malware, including spyware viruses and the like. The NIDS 22 may hold a number of signatures 24 of different types of malware including viruses and spyware and the like and may, for example, be a computer running a program such as “Snort”, an open source intrusion detection/prevention system available at http://www.snort.org, or “Bro”, an intrusion detection system available at http://bro-ids.org.

The present invention may be implemented by programs 26 running on one or more of the computers 20a-20d. In a first implementation, the program 26 runs on a single computer 20d to detect spyware infecting the computer 20d and to provide corresponding signatures 24 by a signature transfer path 28 to the NIDS 22. In this embodiment, the program 26 may alternatively or in addition notify the operator of the computer 20d of the presence of spyware via warning signal 68, for example transmitted to a local or remote monitoring terminal 29.

In a second embodiment, the program 26 runs on computers 20b and 20c. In this mode, the computer 20c provides data about normal computer operation (to be described below) via connection 30 to computer 20b used by that computer 20b in the detection of spyware on computer 20b and/or the generation of signatures or warning signals.

In a third embodiment, the program 26 operates solely on computer 20a and provides two instances of a program, such as a browser, one instance providing data about normal computer operation, and one instance susceptible to spyware infection and under continual supervision. In this embodiment, as will be described below, the outputs of the program instances are compared to detect spyware.

Referring now to FIG. 2, a computer 20 of FIG. 1 may execute an operating system 32 such as the Windows XP operating system commercially available from the Microsoft Company of Redmond, Wash. The operating system 32 provides a user input interface 34, for example, implemented by an application programmer interface (API) understood in the art that may receive user inputs 36 from a user by means of a user interface device 38 such as a keyboard, mouse or other input device well-known in the art. User inputs 36, as will be explained, need not be from a user of the computer 20, but are simply inputs received, for example, from user input interface 34 and treated by application programs as actual inputs from users would be treated.

The operating system 32 may also provide for an Internet interface 40 to network connections 18 or the like also by means of an API.

The interfaces 34 and 40 provide a simple mechanism for application programs 42 to communicate with external hardware and devices. In this case, the application programs 42 may be a browser 44 such as the Internet Explorer browser manufactured by Microsoft. Such a browser 44 may permit one or more plug-ins 46 to enhance or customize the operation of the browser 44 and may also harbor spyware. The program 26 of the present invention may also be an application program 42 with communication via API calls with the interfaces 34 and 40.

Referring still to FIG. 2, the program 26, using interfaces 34 and 40, may monitor outgoing packets 51 from the browser 44 and its plug-ins 46 and may provide the browser 44 and its plug-ins 46 with user inputs 36 through interface 34.

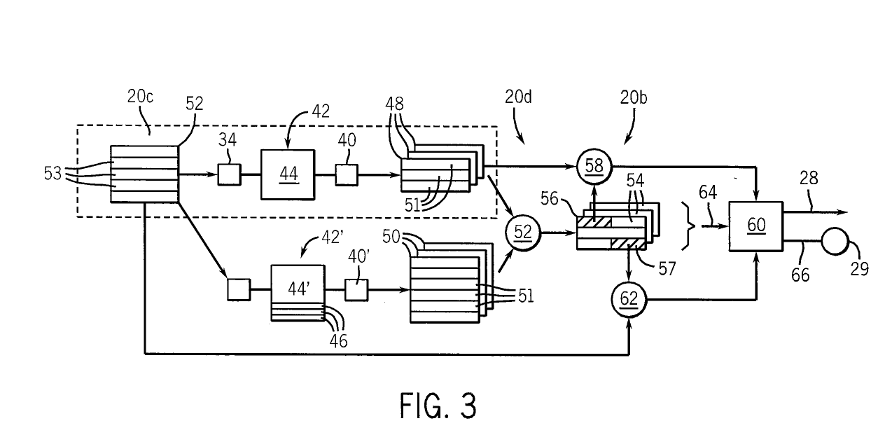

Referring now to FIG. 3, in the first and second embodiment of the invention, the program 26 uses preselected user inputs 53 in a test input set 52 to test an application program 42, in this case the browser 44. In the simplest case, these pre-selected user inputs 53 will be Web addresses in the form of URLs such as might be provided to the browser 44 by a user using user interface device 38 or the like. Ideally, these user inputs 53 of the test input set 52 include common web sites expected to be visited by many users and in particular search engines that might trigger a response from the spyware, for example, “www.google.com” being the URL of the Google search engine.

The user inputs 53 of the test input set 52 are first applied to a clean version of the application program 42 to be tested, where the clean version of the application program 42 is ideally known to be free from spyware and on a machine that is free from spyware. This process may be conducted on a single computer 20d, for example when it is first commissioned, or on a separate machine for example computer 20c being maintained in a pristine state.

The user inputs 53 are provided through interface 34 to the browser 44 which produces output packets 51 through interface 40 that are recorded in a standard behavior table 48 by the program 26. Generally multiple sets of packets 51 are collected for each set of user inputs 53. Referring to the following Table 1 a user input 53 of www.google.com may produce to output packets 51 for standard behavior table 48 corresponding to a request for data from the Google web site and a request for an image embedded in the main page data of the accessed Google web site. This process of generating standard behavior table 48 may be done as infrequently as once.

TABLE 1
Standard Behavior Table

| Input | | |
|---|---|---|
| Number | User Input | Output Packets |
| 1 | www.apple.com | GET /main/css/globablprint.css |
| | | GET /home/2006/ticker.rss |
| | images.apple.com | Get /movies/us/apple/... |
| | | (other packets omitted for clarity) |
| 2 | www.google.com | GET / |
| | | GET /intl/en/images/logo.gif |
| 3 | slashdot.org | GET / |
| | images.slashdot.org | GET /topics/topicnnitendo.gif |
| | | GET /topics/security.gif |
| | | (other packets omitted for clarity) |

Note that each test input set 52 will normally include multiple user inputs 53 for different remote server sites and one or more user inputs 53 for each remote server site.

At a subsequent time on the same computer 20d (in the first embodiment) or on a different unknown computer 20b (in the second embodiment) the same user inputs 53 may be applied through network interface 34′ to new application program 42′ for example being a possibly infected browser 44′ on a new computer 20c or the same browser 44 at a later time on computer 20d. The browser 44′ represents any application program 42 with an unknown state with respect to spyware infection and, in response to the test input set 52, produces through interface 40′ output packets 51 that are collected in an actual behavior table 50 shown in the following Table 2.

TABLE 2
Actual Behavior Table

| Input | | |
|---|---|---|
| Number | User Input | Output Packets |
| 1 | www.apple.com | GET /main/css/globablprint.css |
| | | GET /home/2006/ticker.rss |
| | images.apple.com | GET /movies/us/apple/... |
| | | (other packets omitted for clarity) |
| | | GET /...&theurl=http://www.apple.com |
| | | (additional packets directed to spyware |
| | | site) |
| 2 | www.google.com | GET / |
| | | GET /intl/en/images/logo.gif |
| | | GET /...&theurl=http:// |
| | | www.google.com |
| | | (additional packets directed to spyware |
| | | site) |
| 3 | slashdot.org | GET / |
| | images.slashdot.org | GET /topics/topicnnitendo.gif |
| | | GET /topics/security.gif |
| | | (other packets omitted for clarity) |
| | | GET /...&theurl=http://slashdot.org |
| | | (additional packets directed to spyware |
| | | site) |

Generally, as shown, the actual behavior table 50 may include additional output packets 51 beyond those invoked on the clean machine. In this case, those output packets include captured browsing behavior (in the form of URL's) sent to a spyware server and include a URL of the spyware server (not shown in the table).

Using the data of the standard behavior table 48 and the actual behavior table 50, the program 26 then compares the corresponding output packets of standard behavior table 48 to the actual behavior table 50 for each entry of the user inputs 53 to identify those packets of actual behavior table 50 that are not standard responses as shown by the corresponding record of standard behavior table 48. In this case the packets directed to the spyware site (e.g., GET/...&theurl=http://slashdot.org) are identified as a set of nonstandard packets 54.

The program 26 individually analyzes each set of nonstandard packets 54 with respect to server addresses 56 to which data will be sent. These server addresses 56 are compared by address matcher 58 to the server names found in the output packets 51 of the standard behavior table 48. Information indicating a server address 56 is “unknown”, that is, not found in the standard behavior table 48 is sent to a spyware threat assessor 60 as will be described below.

The packets of each set of nonstandard packet 54 are also analyzed with respect to the user inputs 53 that evoked the set of nonstandard packets 54 by correlator 62 to determine whether there is a correlation between the user inputs 53 and the data 57 being conveyed by the set of nonstandard packets 54 to a remote site. Such correlation would tend to indicate that private user information is being embedded in an outgoing packet. The results of this comparison are also provided to the spyware threat assessor 60.

For many spyware types, the user inputs 53 correlated by the correlator 62 with the data 57 of the set of nonstandard packets 54 may be the most recent user inputs 53. This short time window of comparison is possible because of a motivation of the designers of some types of spyware to react immediately to user inputs 53 for the delivery of advertisements targeted to the user inputs 53. Nevertheless, the time window of user inputs 53 need not be so limited, and previous user inputs 53 for an arbitrary time window may be considered.

Multiple sets of nonstandard packets 54 associated with different user inputs 53 (for example www.apple.com and www.google.com) are then compared against each other to identify the longest common subsequence among the multiple set of nonstandard packets 54. This longest common subsequence is extracted as a potential signature 64 and provided to the spyware threat assessor 60.

The spyware threat assessor 60 operates according to the following Table 3 to output a signature 24 along signature transfer path 28 and/or to notify the user that there is a spyware infection as indicated by warning output 66 depending on the analysis of information from address matcher 58 and correlator 62.

TABLE 3

| | Spyware | Unknown | Correlation to |
|---|---|---|---|
| Score | Infection | Address | User Input |
| 3 | Most Likely | Yes | Yes |
| 2 | Likely | Yes | No |
| 1 | Least Likely | No | — |

Spyware is most likely and thus a highest score is assigned to situations where the remote server address 56 is unknown and user inputs 53 may be correlated to the data 57 of the packets 54. A likely rating is provided if there is an unknown server address but the correlation between data 57 and user inputs 53 cannot be easily made. This second case covers spyware that may, for example, encrypt the data it is sending out from an infected machine. Finally it is least likely that there is a spyware infection if the remote server address 56 is recognized. In this case it is immaterial whether user inputs 53 correlate to data 57. The user may select any score level to trigger a warning output 66 and/or a signature output over signature transfer path 28 depending on a desired level of security.

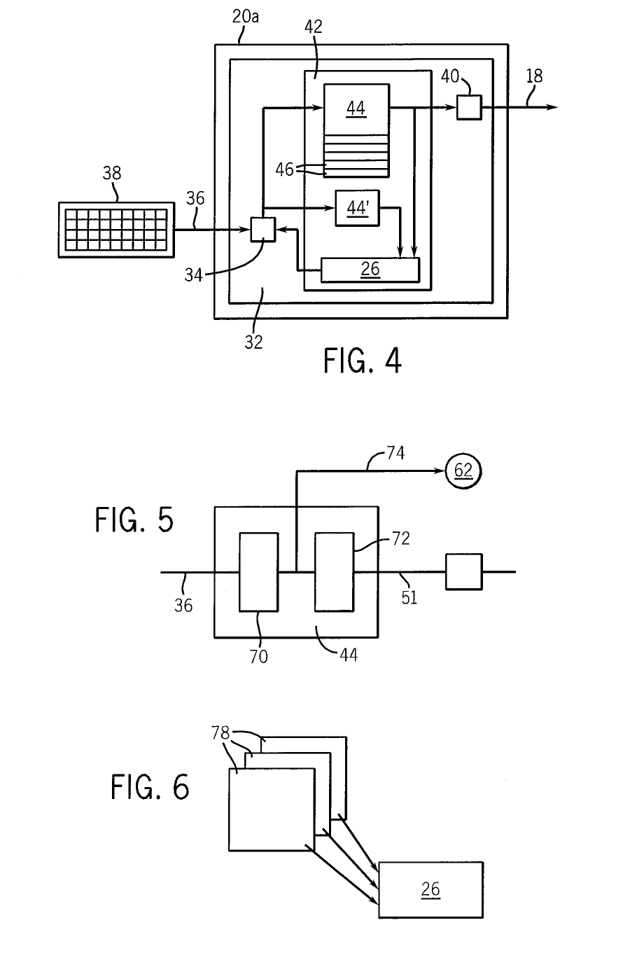

Referring now to FIG. 4, in the third embodiment, the present invention may be implemented on a single computer 20 and incorporated, for example, directly into an application program 42, by creating two independent instances of the application, for example, a browser 44 and browser 44′. Each of browsers 44 and 44′ may receive user inputs 53 from interface 34 applied periodically or when new programs are added by the program 26 as described above. Alternatively, the browsers 44 and 44′ may receive actual input from the user via the user interface device 38 or the like as user inputs 53. Browser 44 differs from browser 44′ in that it cannot receive spyware, in this case by not allowing any plug-ins, and because it does not connect to interface 40. In this way, browser 44′ serves to benchmark uninfected browser behavior.

Spyware detection program 26 is incorporated into the application program 42 to continuously receive inputs and outputs from both the standard browser 44 and the known clean browser 44′ that serve to provide the data of standard behavior table 48 and actual behavior table 50, respectively. With the possibility of continuous real-time operation, program 26 may provide an immediate warning of spyware behavior through warning output 66. Over time, multiple novel packets 54 may be collected to extract a signature that may also be forwarded to another machine.

Referring now to FIG. 5 some user inputs 36 to a browser 44 will be in the form of a “mouse click” or the like which may not be easily compared to data in the packet 51 being sent out. Thus, for example, the user may click on a link in a previously received Web page which produces a packet directed to a Web server identified by that link whose text is extracted by the browser 44 from the Web page. These sorts of user inputs 36 may be captured by the present invention in a specially designed browser which provides the program 26 with access to these derived user inputs 74 transmitted between a browser command processor 76, which receives the mouse click, and an Internet stack 72 that actually outputs the derived user inputs 74.

Referring now to FIG. 6, program 26 may make use of a pre-selected manual list of URLs or the like for user inputs 53 or may perform a search of binary executable files 78, presumably including any spyware executables, to find recognizable URLs that may be added to the user inputs 53 to promote spyware type behavior to create dynamic and automatically generated user inputs 53.

It is specifically intended that the present invention not be limited to the embodiments and illustrations contained herein, but include modified forms of those embodiments including portions of the embodiments and combinations of elements of different embodiments as come within the scope of the following claims. For the purpose of the claims, the term “computer” should be considered to refer not only to a unique processor but also to multiple processors sharing execution of a single task in a distributed processing environment. Likewise multiple computers should be interpreted to include multiple processors, or single processors executing multiple simultaneous tasks or sequential tasks, reflecting the understanding of those of ordinary skill in the art that one can arbitrarily divide or combine a computing task among one or more hardware platforms.

We claim:

1. A method of detecting spyware on a computer comprising the steps of
(a) in a computer having a known clean state, identifying a set of standard output packets generated by the computer in response to a given set of user inputs;
(b) in a computer having an unknown state, monitoring output packets in response to the given set of user inputs to identify differences between the standard output packets and those output packets; and
(c) based on the differences, assess likelihood that the computer having an unknown state is infected with spyware.

2. The method of claim 1 wherein step (c) determines whether the differences in output packets include output packets having an unknown server addresses.

3. The method of claim 1 wherein step (c) determines whether the differences in output packets include output packets that have data correlated with the given set of user inputs.

4. The method of claim 3 wherein step (c) determines whether the differences in output packets include output packets that have data correlated with the given set of user inputs; and;
including the step of assessing a threat level based on whether the differences in output
packets include both one or none of an unknown server address and data correlated with the given set of user inputs.

5. The method of claim 1 wherein the user inputs are automatically generated by a program running on the computer.

6. The method of claim 1 wherein the given set of user inputs is selected from a set of common server addresses.

7. The method of claim 1 wherein the given set is obtained by analyzing executable programs on the computer for URL values.

8. The method of claim 1 wherein the computer having a known clean state and the computer having an unknown state are the same computer hardware at different times with different loaded programs.

9. The method of claim 1 wherein the computer having a known clean state and the computer having an unknown state are the same computer hardware simultaneously running different instances of a program.

10. The method of claim 9 wherein the different instances of a program include two instances of a browser where one instance provides no packet outputs and will not accept plug in programs.

11. The method of claim 1 wherein the computer having a known clean state and the computer having an unknown state are different computer hardware initialized with the same software before step (b).

12. The method of claim 1 further including the step of extracting a signature from the differences and providing it to a monitoring program.

13. The method of claim 12 wherein the signature is a longest common subsequence of the differences.

14. The method of claim 1 further including the step of performing steps (b) and (c) periodically according to time.

15. The method of claim 1 further including the step of performing steps (b) and (c) upon a loading of new programs into the computer of unknown state.

16. At least one computer executing a stored program to perform the method of claim 1.

17. A method automatically generating signatures of spyware comprising the steps of:
(a) in a computer having a known clean state, identifying a set of standard output packets generated by the computer in response to a given set of user inputs;
(b) in a computer having an unknown state, monitoring output packets in response to the
given set of user inputs to identify differences between the standard output packets those output packets; and
(c) extracting a signature based on the differences for use in a network monitor.

18. The method of claim 17 wherein step (c) extracts signatures depending on whether the differences in output packets include output packets having an unknown server address.

19. The method of claim 17 wherein step (c) extracts signatures depending on whether the differences in output packets include output packets that have data correlated with the given set of user inputs.

20. The method of claim 19 wherein step (c) determines whether the differences in output packets include output packets that have data correlated with the given set of user inputs; and
wherein step (c) extracts signatures depending on when whether the differences in output
packets include output packets that have data correlated with the given set of user inputs and whether output packets include output packets having an unknown server address.

21. The method of claim 17 wherein the user inputs are automatically generated by a program running on the computer.

22. The method of claim 17 wherein the given set of user inputs is selected from a set of common server addresses.

23. The method of claim 17 wherein the signature is a longest common subsequence of the differences.

24. At least one computer executing a stored program to perform the method of claim 17.
